(19) United States
(12) Patent Application Publication
(10) Pub. No.: US 2020/0369540 A1
(43) Pub. Date: Nov. 26, 2020

(54) Filter with Natural Chelators

(71) Applicant: Scott Chamberlin, Los Angeles, CA (US)

(72) Inventor: Scott Chamberlin, Los Angeles, CA (US)

(21) Appl. No.: 16/836,394

(22) Filed: Mar. 31, 2020

Related U.S. Application Data
(60) Provisional application No. 62/827,392, filed on Apr. 1, 2019.

(51) Int. Cl. C02F 1/68

(52) U.S. Cl. CPC C02F 1/68

(57) ABSTRACT

Water is filtered, then a filtering material is added to the water after it is filtered. The filtering material can include a zeolite that bonds with and removes heavy metals from a human body. The water processing part produces filtered water with the filtering material therein.

This application claims priority from Provisional application Ser. No. 62/827,392, filed Apr. 1, 2019, the entire contents of which are herewith incorporated by reference.

### BACKGROUND

Different kind of filtering systems are known for removing impurities from water (and other liquids) prior to delivery of those filtered liquids to a consumer.

Many kinds of water purifying filters exist. These filters often remove many different things from the water, including both desirable and undesirable minerals. For example, a reverse osmosis (“RO”) filter will typically remove almost all minerals of all kinds from the water.

Mineral cartridges have been employed to re-minimalize water after it has been filtered by reverse osmosis because reverse osmosis removes more than 90% of the total dissolved solids including the trace materials found in water. Mineral cartridges can be used to replace these minerals which have been stripped.

### SUMMARY

The inventor recognizes that after certain kinds of filtration, it may be beneficial to add back in certain minerals and materials to the water.

According to an embodiment, a mineral adding filter is described that adds in certain kinds of materials to the water after the minerals have been removed.

In one embodiment, after filtering the water, the mineral adding filter adds materials that are themselves filters. In an embodiment, for example, the filter adds in natural chelators to remove heavy metals. These chelators, in the human body, may actually help to remove and suppress toxins in the human body. In one embodiment, the chelators may be zeolites that are added into the water.

Another embodiment describes adding zeolites to drinking water, to provide the natural chelating effect of the zeolites in the drinking water.

### DETAILED DESCRIPTION

A first embodiment describes a filter which is used prior to water being drank by a consumer, but after other filtrations if any have been carried out. This embodiment adds a filter into the water after the filtering has been carried out. In the embodiment, the minerals added to the drinking water that have their own health benefits. In this embodiment, a volcanic material called zeolites is added to the drinking water. Zeolites have been this subject of over 3000 studies, and have been found to be a natural chelator to bond with, and remove, heavy metals from within the human body. By drinking water with zeolites, the inventor postulates that heavy metals will be removed from the body by the zeolites attracting those heavy metals with their negative charge, and their unique porous structure. In addition, the zeolites can balance pH and have other health benefits.

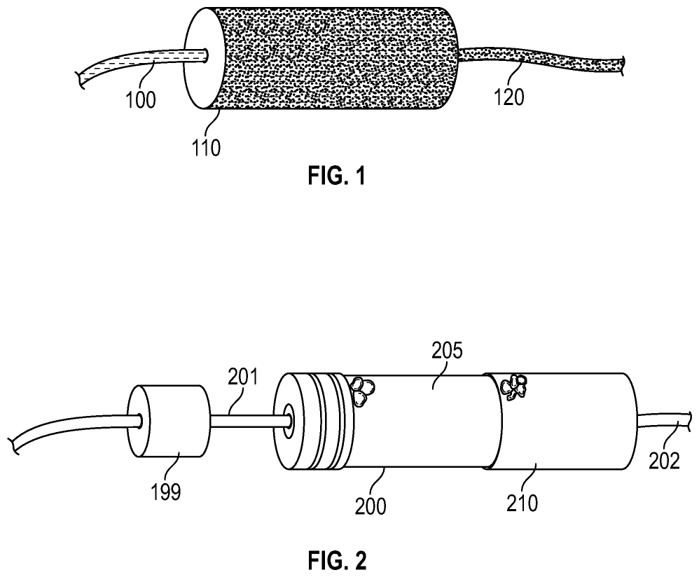

In an embodiment, the zeolites can be added by using a special filter shown in FIG. 1. Input water 100, which can be for example filtered water filtered by a reverse osmosis unit or can be simply water from the tap, is input to a filter 110 which is impregnated with zeolites and trace materials. The zeolites and trace materials dissolve into the water, producing output water on the line 120 which includes water with the zeolites and trace materials dissolved therein.

FIG. 2 shows an alternative embodiment, where the input water 201 is input to a refillable filter case 200, with a screw off top, having an internal section of zeolites 205, packed against a second area of trace minerals 210, leaving to an outlet 202.

Unlike the prior art which filters water, the present application describes receiving filtered water into a filter device which actually adds a filtering material into the filtered water. That is, the filtered water receives a filtering material (here zeolites) and also receives trace materials such as the ones which have been stripped.

The filter 110 can also include a mineral cartridge, to replace the minerals which have been stripped by the reverse osmosis filtration process for example. In addition to the mineral that have been stripped, however, the invention can add zeolites to the mineral cartridge adding those zeolites to the drinking water for their resulting health benefits.

According to an alternative embodiment, the zeolite cartridge can be used with any water system, commercial or consumer, to add just zeolites, or to add both minerals and zeolites, to the drinking water. This can also be used to add zeolites to any other kind of water, such as pool water, spa water or whole house filtration systems.

In another embodiment, zeolites are added to drinking water, which is distributed as zeolite impregnated water.

Although only a few embodiments have been disclosed in detail above, other embodiments are possible, and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, the zeolite impregnated water can be used for other applications.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A filtered water processing apparatus, comprising:
a source of filtered water, coupled via a conduit;
a water processing part, receiving the filtered water via the conduit, and adding a filtering material to the filtered water,
where the filtering material bonds with and removes heavy metals from a human body,
the water processing part producing an output of the water with the filtering material therein.

2. The apparatus as in claim 1, wherein the water processing part also adds trace materials to the water.

3. The apparatus as in claim 2, further comprising a water filter, which removes materials from the water, and produces the source of filtered water into the water processing part.

4. The apparatus as in claim 1, wherein the water processing part includes zeolites therein as the filtering material, which adds the zeolites to the filtered water.

5. The apparatus as in claim 1, wherein the water processing part adds a natural chelator to the filtered water.

6. The apparatus as in claim 1, wherein the water processing part includes a filter housing with the filtering material therein.

7. A water processing apparatus, comprising:
a water filter that removes items from water, and produces filtered water;
a water processing part, receiving the filtered water via the conduit, and adding a filtering material that is itself a filter, to the filtered water,
where the filtering material bonds with and removes heavy metals from a human body,
the water processing part producing an output of the water with the filtering material therein.
